(19) United States
(12) Patent Application Publication
(10) Pub. No.: US 2021/0294663 A1
(43) Pub. Date: Sep. 23, 2021

(54) INFORMATION PROCESSING APPARATUS

(71) Applicant: HONDA MOTOR CO., LTD., Tokyo (JP)

(72) Inventors: Shuhei MITANI, WAKO-SHI (JP); Takashi NOGUCHI, WAKO-SHI (JP); Koichi KOJIMA, WAKO-SHI (JP); Kotaro SEIKE, WAKO-SHI (JP); Yasuhisa ISHIDA, WAKO-SHI (JP)

(21) Appl. No.: 17/202,963

(22) Filed: Mar. 16, 2021

(30) Foreign Application Priority Data
Mar. 17, 2020 (JP) 2020-046491

(51) Int. Cl. G06F 9/50; G06F 9/54

(52) U.S. Cl. CPC G06F 9/5044; G06F 9/546; G06F 9/5055

(57) ABSTRACT

An intermediate layer includes a first intermediate layer and a second intermediate layer. The first intermediate layer and the second intermediate layer each contact hardware and application software. The first intermediate layer supports the application software that transmits and receives specified information; and the second intermediate layer is capable of supporting the application software that transmits and receives unspecified information, which is not the application software that transmits and receives specified information.

### CROSS-REFERENCE TO RELATED APPLICATION

This application is based upon and claims the benefit of priority from Japanese Patent Application No. 2020-046491 filed on Mar. 17, 2020, the contents of which are incorporated herein by reference.

### BACKGROUND OF THE INVENTION

### Field of the Invention

The present invention relates to an information processing apparatus that includes a hierarchical structure having hardware, application software, and an intermediate layer connecting the hardware and application software.

### Description of the Related Art

Japanese Laid-Open Patent Publication No. 2009-230673 discloses an information processing apparatus (calculator) that has a hierarchical structure and includes hardware, application software, and an intermediate layer. This information processing apparatus includes an HAL (Hardware Abstraction Layer) and a framework (Framework) in the intermediate layer.

### SUMMARY OF THE INVENTION

There are cases where a commonly used general-purpose framework, such as Android (Registered Trademark), for example, is used as the framework. An information processing apparatus using a general-purpose framework is capable of installing unspecified application software, but the transmission and reception of information between the hardware and devices connected thereto is limited to specified information. This is because the intermediate layer including the general-purpose framework supports only specified information on the hardware side, and does not support other information. Therefore, in order to install application software that uses information that cannot be transmitted or received at the time when the information processing apparatus is created (information other than the specified information), it is necessary to modify the HAL, the HAL I/F, and the framework before installing the application software, in order to be able to provide the application software with information other than the specified information.

The present invention has been devised taking into consideration the aforementioned problem, and has the object of providing an information processing apparatus that makes it possible to use application software that transmits and receives unspecified information, without modifying the HAL, HAL I/F, and framework.

An aspect of the present invention is an information processing apparatus including a hierarchical structure including hardware, application software, and an intermediate layer configured to connect the hardware and the application software, wherein the intermediate layer includes a first intermediate layer and a second intermediate layer; the first intermediate layer and the second intermediate layer each contact the hardware and the application software; the first intermediate layer supports the application software that transmits and receives specified information; and the second intermediate layer is configured to support the application software that transmits and receives unspecified information, which is not the application software that transmits and receives specified information.

According to the present invention, it is possible to use application software that transmits and receives unspecified information, without modifying the HAL, HAL I/F, and framework.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing an example of an information processing apparatus;

FIG. 2 is a diagram showing a hierarchical structure of a general-purpose computer system;

FIG. 3 is a diagram showing a hierarchical structure of the information processing apparatus;

FIG. 4A shows a relationship between messages and applications of a general-purpose computer system, and FIG. 4B shows a relationship between messages and applications of the information processing apparatus;

FIG. 5 shows an access control table; and

FIG. 6 is a flow chart of a process performed by an extension framework when an unspecified application operates.

### DESCRIPTION OF THE PREFERRED EMBODIMENTS

Preferred embodiments of an information processing apparatus according to the present invention will be presented and described below with reference to the accompanying drawings.

### [1. Configuration of the Information Processing Apparatus 10]

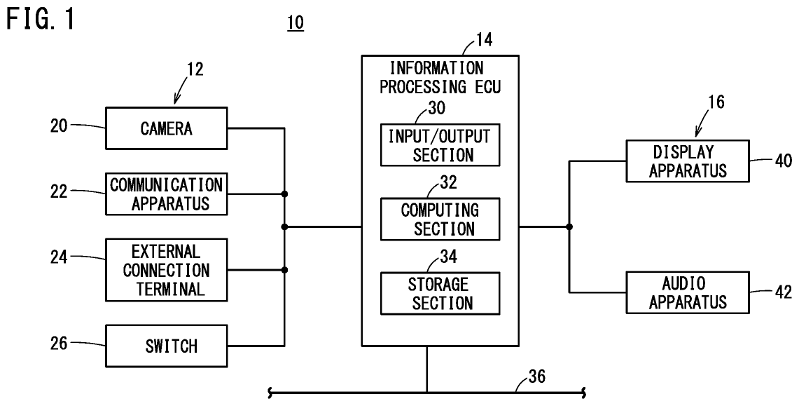

The configuration of an information processing apparatus 10 provided in a vehicle is described using FIG. 1. The information processing apparatus 10 provides various types of information to an occupant of the vehicle, such as video of a region behind the vehicle, entertainment information, webpage information, and electronic mail information, for example. The information processing apparatus 10 includes an input apparatus 12, an information processing ECU 14, and an output apparatus 16.

The input apparatus 12 includes a camera 20, a communication apparatus 22, an external connection terminal 24, a switch 26, and the like. The camera 20 captures an image of the region behind the vehicle, and outputs captured image information to the information processing ECU 14. The communication apparatus 22 includes a short-range wireless communication terminal device such as Wi-Fi (Registered Trademark) and Bluetooth (Registered Trademark), for example; a TCU (Telematics Control Unit); a receiver for FM broadcasts, AM broadcasts, beacons, and the like; and the like. The communication apparatus 22 outputs the various types of received information to the information processing ECU 14. The external connection terminal 24 is a plug insertion port that connects an external apparatus and the information processing ECU 14 in a manner to be capable of bidirectional communication, and is a USB port or the like, for example. The switch 26 is an HMI with which the occupant manipulates the information processing apparatus 10, and outputs a manipulation signal corresponding to the manipulations made by the occupant to the information processing ECU 14.

The information processing ECU 14 includes an input/output section 30, a computing section 32, and a storage section 34. The input/output section 30 includes an A/D conversion circuit, a communication interface, and the like. The computing section 32 includes processors such as a CPU, an NPU, a GPU, and the like. The computing section 32 realizes various functions by executing various types of software stored in the storage section 34. The storage section 34 includes a RAM, a ROM, and the like. The storage section 34 stores various types of software. The information processing ECU 14 performs data communication with another ECU, via a CAN bus 36.

The output apparatus 16 includes a display apparatus 40 and an audio apparatus 42. The display apparatus 40 outputs video according to video information output by the information processing ECU 14. The audio apparatus 42 outputs sound according to audio information output by the information processing ECU 14.

### [2. Hierarchical Structure]

The following describes the hierarchical structure of a general-purpose computer system 50 and the hierarchical structure of the information processing apparatus 10.

### [2.1. Hierarchical Structure of the General-Purpose Computer System 50]

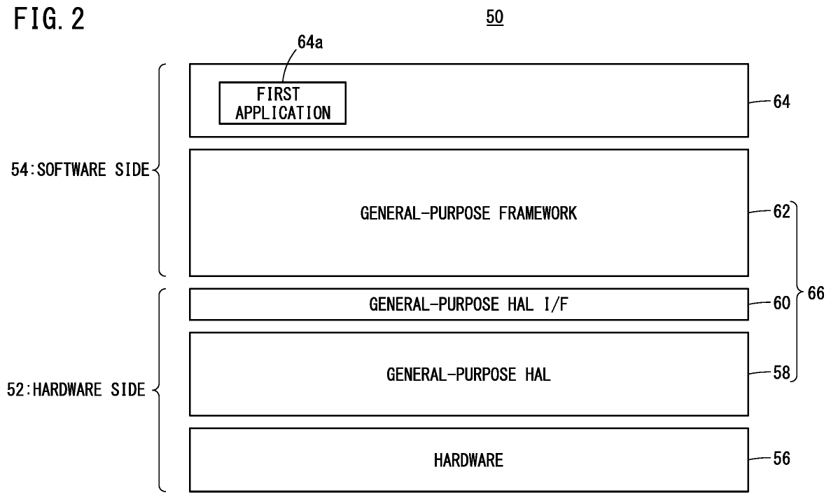

The hierarchical structure of the general-purpose computer system 50, which uses a general-purpose framework (Framework), is described using FIG. 2. In this Specification, the general-purpose framework is referred to as a general-purpose framework 62. Android is given as an example of the general-purpose framework 62.

The computer system 50 is formed of a hierarchy 52 on the hardware side and a hierarchy 54 on the software side. In the hierarchy 52, hardware 56 is positioned in the lowest layer, a general-purpose HAL 58 is positioned above the hardware 56, and a general-purpose HAL interface (general-purpose HAL I/F 60) is positioned above the general-purpose HAL 58. In the hierarchy 54, the general-purpose framework 62 is positioned on the side connected to the hierarchy 52, and application software [application 64 (first application 64a)] is positioned above the general-purpose framework 62. The general-purpose HAL 58, the general-purpose HAL I/F 60, and the general-purpose framework 62 are an intermediate layer 66 positioned between the hardware 56 and the application 64. The intermediate layer 66 connects the hardware 56 and the application 64. The application 64 operates with the general-purpose framework 62 as a platform.

### [2.2. Hierarchical Structure of the Information Processing Apparatus 10]

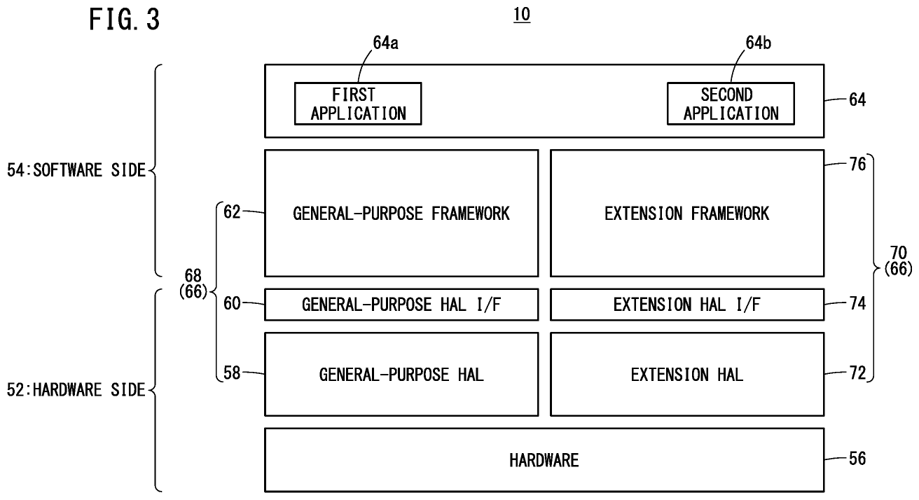

The hierarchical structure of the information processing apparatus 10 is described using FIG. 3. The hardware 56 shown in FIG. 3 corresponds to each configuration shown in FIG. 1. The software shown in FIG. 3, which is not part of the hardware 56, is stored in the storage section 34 shown in FIG. 1.

In the same manner as the computer system 50, the information processing apparatus 10 includes an intermediate layer 66 positioned between the hardware 56 and applications 64 (first application 64a and second application 64b). This intermediate layer 66 includes a first intermediate layer 68 that includes a general-purpose framework 62, and a second intermediate layer 70 that includes an extension framework 76. The first intermediate layer 68 and the second intermediate layer 70 each contact the hardware 56 and the applications 64.

The hierarchical structure of the first intermediate layer 68 is the same as the hierarchical structure of the intermediate layer 66 of the computer system 50. That is, in the first intermediate layer 68, the general-purpose HAL 58 is positioned above the hardware 56, the general-purpose HAL I/F 60 is positioned above the general-purpose HAL 58, and the general-purpose framework 62 is positioned above the general-purpose HAL I/F 60.

On the other hand, in the second intermediate layer 70, an extension HAL 72 is positioned above the hardware 56, an extension HAL I/F 74 is positioned above the extension HAL 72, and the extension framework 76 is positioned above the extension HAL I/F 74. In the second intermediate layer 70, the extension HAL 72 and the extension HAL I/F 74 are in the hierarchy 52 on the hardware side, and the extension framework 76 is in the hierarchy 54 on the software side.

The extension HAL 72 is an HAL that is different from the general-purpose HAL 58 positioned in the same layer (i.e., in the same hierarchy level). The extension HAL I/F 74 is an interface that is different from the general-purpose HAL I/F 60 positioned in the same layer. The extension framework 76 is a framework different from the general-purpose framework 62 positioned in the same layer.

The first intermediate layer 68 causes an application 64 that is capable of operating only by transmitting and receiving specified information, e.g. the first application 64a, to operate to thereby control the hardware 56 (short-range wireless communication terminal device, audio apparatus 42, or the like, for example). The application 64 that is capable of operating only by transmitting and receiving specified information refers to an application 64 that is pre-installed or scheduled for installation in a manner to operate with the general-purpose framework 62 as the platform. In other words, an application 64 that is capable of operating only by transmitting and receiving specified information refers to an application capable of operating only with the general-purpose framework 62. On the other hand, the first intermediate layer 68 is not configured to cause an application 64 that transmits and receives unspecified information, e.g. the second application 64b, to operate. An application 64 that transmits and receives unspecified information refers to an application 64 that cannot transmit and receive information using only the general-purpose framework 62 as a platform, i.e., cannot operate using only the general-purpose framework 62 as a platform. In other words, an application 64 that transmits and receives unspecified information refers to an application 64 that cannot operate in combination with only the general-purpose framework 62.

In contrast to this, the second intermediate layer 70 is capable of changing a setting to make it possible to operate an unspecified application 64, e.g. the second application 64b for realizing a function unique to a vehicle. That is, the second intermediate layer 70 is an intermediate layer 66 for realizing a function that is not expected to be realized by the general-purpose framework 62.

The first intermediate layer 68 is a portion in which the settings can be changed by a supplier and user of the general-purpose framework 62, and is a portion capable of transmitting and receiving only specified information. On the other hand, the second intermediate layer 70 is a portion in which the settings for the transmission and reception of unspecified information can be changed by the user of the general-purpose framework 62 afterwards.

### [3. Operation of the Information Processing Apparatus 10]

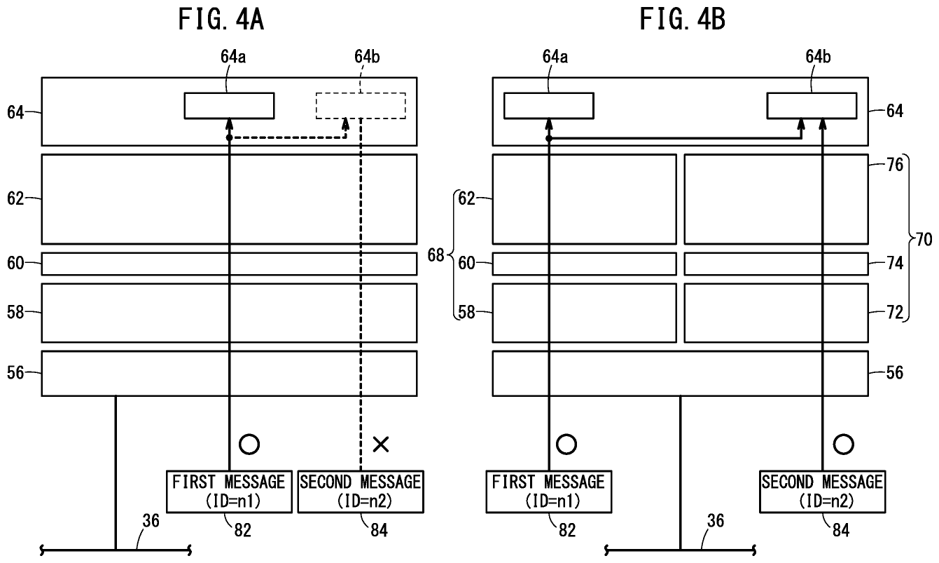

Differences between the operations of the computer system 50 and the information processing apparatus 10 are described using FIGS. 4A and 4B. First, a case is envisioned in which the computer system 50 is loaded in a vehicle and an application 64 that transmits and received unspecified information, the second application 64b in this case, is installed, in order to describe problems with the computer system 50.

As an example, among messages forwarded by the CAN bus 36, the first application 64a uses a first message 82 (ID=n1) but does not use a second message 84 (ID=n2). In contrast to this, the second application 64b that is added afterwards uses both the first message 82 and the second message 84.

As shown in FIG. 4A, in the computer system 50, the second application 64b can access the first message 82 but cannot access the second message 84. This is because the general-purpose HAL 58 and the general-purpose HAL I/F 60 are not set to be able to use messages that are not being used by the first application 64a. This is further because, in the control layer (API) of the general-purpose framework 62, the first message 82 used by the first application 64a is defined, but the second message 84 that is not used by the first application 64a is not defined. Accordingly, in the computer system 50, the second application 64b that transmits and receives unspecified information cannot operate.

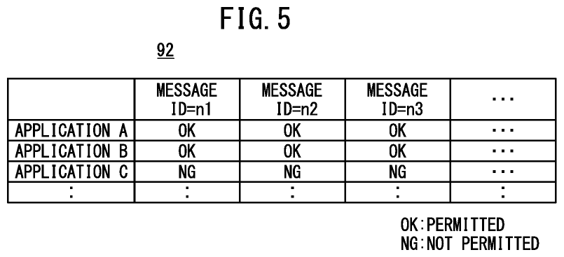

On the other hand, as shown in FIG. 4B, in the information processing apparatus 10, the second application 64b can access both the first message 82 and the second message 84. This is because the extension HAL 72 and the extension HAL I/F 74 can change the settings afterwards so as to make it possible to use messages that the application 64 is not using. Furthermore, the extension framework 76 determines a message that can be accessed by the application 64, based on an access control table 92 that is shown in FIG. 5. The access control table 92 is stored in the storage section 34 and managed by the API (control layer) of the extension framework 76. The access control table 92 defines permission information, which indicates whether or not access is permitted (OK or NG), for each application 64 and each message. The access control table 92 is a so-called white list. If an unspecified application 64, e.g. the second application 64b, is installed and the second application 64b is an application 64 recorded in the access control table 92, the extension framework 76 references the access control table 92. On the other hand, if the second application 64b is an application 64 that is not recorded in the access control table 92, the extension framework 76 recognizes this second application 64b as a shared application 64.

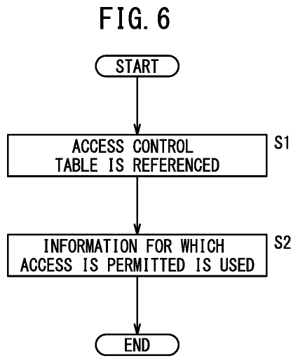

The process performed by the extension framework 76 when the second application 64b operates is described using FIG. 6.

At step S1, the extension framework 76 references the access control table 92. When step S1 ends, the process moves to step S2.

At step S2, the extension framework 76 causes the second application 64b to use the message for which access is permitted (OK in FIG. 5), and does not allow the second application 64b to use the message for which access is not permitted (NG in FIG. 5).

[4. Technical Concepts Obtainable from the Embodiment]

The following is a record of technical concepts that can be understood from the above embodiment.

One aspect of the present invention is an information processing apparatus 10 that includes a hierarchical structure having hardware 56, application software (application 64), and an intermediate layer 66 that connects the hardware 56 and the application software (application 64), wherein:
the intermediate layer 66 includes a first intermediate layer 68 and a second intermediate layer 70;
the first intermediate layer 68 and the second intermediate layer 70 each contact the hardware 56 and the application software (application 64);
the first intermediate layer 68 supports the application software (first application 64a) that transmits and receives specified information; and
the second intermediate layer 70 is capable of supporting the application software (second application 64b) that transmits and receives unspecified information, which is not the application software (first application 64a) that transmits and receives specified information.

The above configuration includes the second intermediate layer 70 that is capable of supporting the application software 64 (second application 64b) that transmits and receives unspecified information. Therefore, according to the above configuration, it is possible to flexibly support (flexibly deal with) information (second message 84) of hardware 56 that is used by an application 64 that transmits and receives unspecified information, e.g. the second application 64b that is newly developed or the like.

In one aspect of the present invention:
the intermediate layer 66 may include a HAL; and
the HAL may include a first HAL (general-purpose HAL 58) of the first intermediate layer 68 and a second HAL (extension HAL 72) of the second intermediate layer 70.

In one aspect of the present invention:
the intermediate layer 66 may include a framework positioned above the HAL;
the framework may include a first framework (general-purpose framework 62) and a second framework (extension framework 76) in the same hierarchy level;
the first framework (general-purpose framework 62) may support the first HAL (general-purpose HAL 58); and
the second framework (extension framework 76) may support the second HAL (extension HAL 72).

In one aspect of the present invention:
the second HAL (extension HAL 72) and the second framework (extension framework 76) may be capable of transmitting and receiving, between the hardware 56 and the application software (second application 64b) that transmits and receives unspecified information, unspecified information other than specified information transmitted and received between the hardware 56 and the specified application software (first application 64a) that transmits and receives specified information.

In one aspect of the present invention:
a table (access control table 92) that defines whether each individual message that is transmitted and received on the hardware 56 side can be used by each application software (application 64) may be included;
the second framework may include a control layer that controls the application software (second application 64b);
the control layer may cause the application software (second application 64b) to use a message that is defined as being usable in the table (access control table 92), among all of the messages; and
the content of the table (access control table 92) may be managed for each application software (second application 64b) and each message.

According to the above configuration, an application 64 is permitted to access only the messages that is used by this application 64 and not permitted to access the messages not used by this application 64. Furthermore, according to the above configuration, when an unspecified application 64, e.g. the second application 64b that is newly developed, is added, the access control table 92 is updated and it is possible to control access to each individual message for each application 64. As a result, each individual application 64 cannot access unnecessary messages, and therefore overall security can be ensured.

In one aspect of the present invention:
the table (access control table 92) may be rewritten based on setting information defining a message to be used by new application software (second application 64b) when the new application software (second application 64b) is added.

The information processing apparatus according to the present invention is not limited to the above-described embodiments, and it goes without saying that various configurations could be adopted therein without departing from the scope of the present invention.

What is claimed is:

1. An information processing apparatus comprising a hierarchical structure including hardware, application software, and an intermediate layer configured to connect the hardware and the application software, wherein:
the intermediate layer includes a first intermediate layer and a second intermediate layer;
the first intermediate layer and the second intermediate layer each contact the hardware and the application software;
the first intermediate layer supports the application software that transmits and receives specified information; and
the second intermediate layer is configured to support the application software that transmits and receives unspecified information, which is not the application software that transmits and receives specified information.

2. The information processing apparatus according to claim 1, wherein:
the intermediate layer includes a HAL (Hardware Abstraction Layer); and
the HAL includes a first HAL of the first intermediate layer and a second HAL of the second intermediate layer.

3. The information processing apparatus according to claim 2, wherein:
the intermediate layer includes a framework positioned above the HAL;
the framework includes a first framework and a second framework in a same hierarchy level;
the first framework supports the first HAL; and
the second framework supports the second HAL.

4. The information processing apparatus according to claim 3, wherein:
the second HAL and the second framework are configured to transmit and receive, between the hardware and the application software that transmits and receives unspecified information, unspecified information other than specified information transmitted and received between the hardware and the application software that transmits and receives specified information.

5. The information processing apparatus according to claim 3, comprising:
a table configured to define whether each individual message that is transmitted and received on a side of the hardware is usable by each application software; wherein:
the second framework includes a control layer configured to control the application software;
the control layer causes the application software to use a message that is defined as being usable in the table, among all of the messages; and
content of the table is managed for each application software.

6. The information processing apparatus according to claim 5, wherein:
the table is rewritten based on setting information defining the message to be used by new application software when the new application software is added.
